(19) United States
(12) Patent Application Publication
(10) Pub. No.: US 2024/0231668 A1
(43) Pub. Date: Jul. 11, 2024

(54) INDUSTRIAL INTERNET-BASED SMART ENERGY MANAGEMENT AND CONTROL PLATFORM

(71) Applicants: COSMO INSTITUTE OF INDUSTRIAL INTELLIGENCE (QINGDAO) CO., LTD., Shandong (CN); CAOS IOT TECHNOLOGY CO., LTD., Shandong (CN); COSMO DIGITAL TECHNOLOGY (QINGDAO) CO., LTD., Qingdao, Shandong (CN)

(72) Inventors: Yong WANG, Shandong (CN); Junling WANG, Shandong (CN); E YU, Shandong (CN); Xiang GAN, Shandong (CN)

(21) Appl. No.: 18/557,910

(22) PCT Filed: Jul. 12, 2022
(86) PCT No.: PCT/CN2022/105147

§ 371 Date: Oct. 27, 2023

(30) Foreign Application Priority Data
Jul. 15, 2021 (CN) 202110801508.1

(51) Int. Cl. G06F 3/06

(52) U.S. Cl. CPC G06F 3/0647; G06F 3/0604; G06F 3/067

(57) ABSTRACT

An industrial Internet-based smart energy management and control platform including an edge layer, an infrastructure as a service, a platform as a service, software as a service, and an application layer. The edge layer collects data from enterprises, merge collected first data to obtain second data. The infrastructure as a service is configured to provide a data migration function and a data service based on the second data. The platform as a service is configured to perform data monitoring and data analysis on the multiple enterprises based on the function and the service provided by the infrastructure as a service. The software as a service is configured to provide a business management and control function based on a data monitoring result and a data analysis result of the platform as a service. The application layer is configured to provide an energy management scheme for the software as a service.

### RELATED APPLICATIONS

This disclosure claims priority to Chinese Patent Application No. 202110801508.1 filed with the China National Intellectual Property Administration (CNIPA) on Jul. 15, 2021, the disclosure of which is incorporated herein by reference in its entirety.

### TECHNICAL FIELD

Embodiments of the present application relate to the technical field of smart home appliances, for example, an industrial Internet-based smart energy management and control platform.

### BACKGROUND

The industrial Internet is an industry and application ecology formed by the all-round and deep integration of the Internet and a new generation of information technology and industrial systems. The industrial Internet is the key comprehensive information infrastructure for the development of industrial intelligence and a commanding point for a new round of global industrial competition. The concept and significance of an industrial Internet platform, as a core carrier for the development of industrial digitalization and intelligence, are gradually acknowledged by the industry. Various industrial entities around the world are actively deploying the industrial Internet platform, and the industrial Internet platform has entered a full outbreak period. The technology of the industrial Internet has been widely applied to the digital management of manufacturing and can achieve wide device connections, flexible deployment, and modular combinations.

However, an industrial Internet management platform in the related art has diverse data collecting devices, data formats are independent and difficult to unify between enterprises and even between different departments of the same enterprise, and data applicability is low. For example, the industrial Internet platform in the related art cannot manage and control the waste of energy in time, so that there are widespread problems of uncontrol flowing, undiscovered venting and leakage of energy.

### SUMMARY

Embodiments of the present application provide an industrial Internet-based smart energy management and control platform for achieving the unified collection, management, and control of data.

The embodiments of the present application provide an industrial Internet-based smart energy management and control platform including an edge layer, an infrastructure as a service, a platform as a service, software as a service, and an application layer.

The edge layer is configured to collect data from multiple enterprises through a unified data collector, merge collected first data based on edge computing technology, and store second data after merging in a cloud platform.

The infrastructure as a service is configured to provide a data migration function and a data service based on the second data stored in the cloud platform.

The platform as a service is configured to perform data monitoring and data analysis on the multiple enterprises based on the data migration function and the data service provided by the infrastructure as a service.

The software as a service is configured to provide a business management and control function based on a data monitoring result and a data analysis result of the platform as a service.

The application layer is configured to provide an energy management scheme for the software as a service.

### BRIEF DESCRIPTION OF THE DRAWINGS

The drawings used in the description of embodiments of the present application are briefly described below. The drawings described below merely illustrate some embodiments of the present application, and those of ordinary skill in the art may obtain other drawings based on the contents of the embodiments of the present application and these drawings on the premise that no creative work is done.

FIG. 1 is a structure diagram of an industrial Internet-based smart energy management and control platform according to an embodiment of the present application.

FIG. 2 is a structure diagram of another industrial Internet-based smart energy management and control platform according to an embodiment of the present application.

FIG. 3 is a functional diagram of a big data application sub-platform in a platform as a service included in another industrial Internet-based smart energy management and control platform according to an embodiment of the present application.

### DETAILED DESCRIPTION

Technical solutions in embodiments of the present application are described below in conjunction with drawings. The embodiments described below are part, not all of the embodiments of the present application. Based on the embodiments of the present application, all other embodiments obtained by those skilled in the art without creative work are within the scope of the present application.

It is to be noted that the terms “system” and “network” are generally used interchangeably in the embodiments of the present application. The term “and/or” mentioned in the embodiments of the present application refers to any or all combinations of one or more relevant items listed. The terms such as “first” and “second” in the description, claims, and drawings of the present disclosure are used to distinguish between different objects and not to limit a particular order.

It is to be further noted that the embodiments of the present application may be implemented separately or implemented in combination with each other.

The names of messages or information exchanged between multiple apparatuses in the embodiments of the present disclosure are only for illustrative purposes and are not intended to limit the scope of such messages or information.

The technical solutions in the embodiments of the present application are described hereinafter in conjunction with drawings and embodiments.

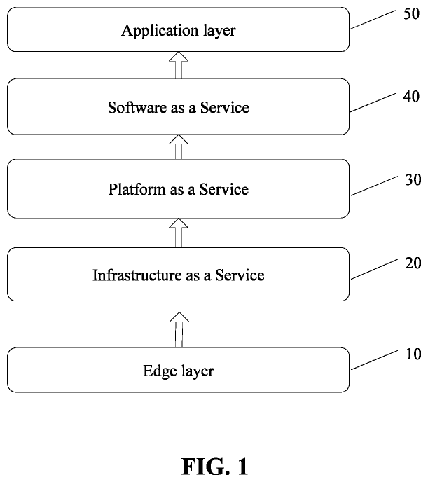

FIG. 1 is a structure diagram of an industrial Internet-based smart energy management and control platform according to an embodiment of the present application. The embodiment is applicable to the case where data are collected, managed, and controlled in a unified manner based on the technology of the industrial Internet. The platform may be configured in an industrial Internet platform. As shown in FIG. 1, the industrial Internet-based smart energy management and control platform according to the embodiment includes an edge layer 10, an infrastructure as a service (IaaS) 20, a platform as a service (PaaS) 30, software as a service (SaaS) 40, and an application layer 50.

The edge layer 10 is configured to collect data from multiple enterprises through a unified data collector, merge collected first data based on edge computing technology, and store second data after merging in a cloud platform.

It is to be noted that the second data is obtained through merging the collected first data based on the edge computing technology.

The infrastructure as a service 20 is configured to provide a data migration function and a data service based on the second data stored in the cloud platform.

The platform as a service 30 is configured to perform data monitoring and data analysis on the multiple enterprises based on the data migration function and the data service provided by the infrastructure as a service 20.

The software as a service 40 is configured to provide a business management and control function based on a data monitoring result and a data analysis result of the platform as a service 30.

The application layer 50 is configured to provide an energy management scheme for the software as a service 40.

According to one or more embodiments of the present disclosure, collecting data from the multiple enterprises through the unified data collector includes: collecting data from instruments, sensors, energy devices, and Internet of things devices of the multiple enterprises through the unified data collector.

According to one or more embodiments of the present disclosure, storing the second data in the cloud platform includes: storing the second data in at least one of a public cloud, a private cloud, or a hybrid cloud.

According to one or more embodiments of the present disclosure, providing the data migration function based on the data stored in the cloud platform includes: supporting, based on a unified interface standard CPI, a migration of the first data between the cloud platform and each enterprise.

According to one or more embodiments of the present disclosure, providing the data service based on the data stored in the cloud platform includes: providing a cloud storage service, a virtual machine service, a network service, a log service, and a security service based on the first data.

According to one or more embodiments of the present disclosure, the business management and control function includes a field problem alert function and a big data analysis and prediction function.

According to one or more embodiments of the present disclosure, the software as a service 40 includes an application (APP) function, a cloudified software function, a push service function, an offline application function, and a WeChat mini-program function.

According to one or more embodiments of the present disclosure, the energy management scheme includes a water management scheme, an electric energy management scheme, a compressed air management scheme, a steam heat management scheme, and a special gas management scheme.

According to one or more embodiments of the present disclosure, collecting data includes collecting real-time data of a predetermined medium, collecting data of a geographic information system, collecting device data, and collecting video data, where the predetermined medium includes electricity, water, gas, heat, wind, coal, and oil.

According to one or more embodiments of the present disclosure, that the infrastructure as a service 20 provides the cloud storage service based on the first data collected by the edge layer 10 includes: migrating the first data collected by the edge layer 10 between the multiple enterprises through a predetermined interface standard.

The industrial Internet-based smart energy management and control platform according to the embodiment includes the edge layer, the infrastructure as a service, the platform as a service, the software as a service, and the application layer. Data are collected from the multiple enterprises through the unified data collector. The collected first data are merged based on the edge computing technology, and the second data after merging are stored in the cloud platform. The data migration function and the data service are provided based on the second data stored in the cloud platform. The data monitoring and the data analysis are performed on the multiple enterprises based on the data migration function and the data service provided by the infrastructure as a service. The business management and control function is provided based on the data monitoring result and the data analysis result of the platform as a service, and the energy management scheme is provided for the software as a service. Thus, data can be collected, managed, and controlled in the unified manner.

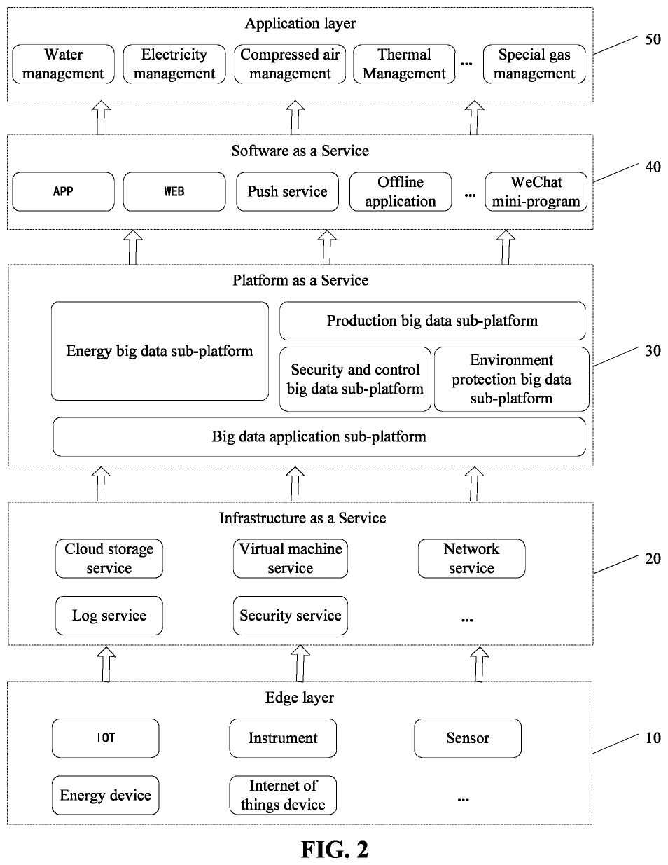

FIG. 2 is a structure diagram of another industrial Internet-based smart energy management and control platform according to an embodiment of the present application. This embodiment is an optimization and improvement based on the preceding embodiment. As shown in FIG. 2, the industrial Internet-based smart energy management and control platform according to the embodiment includes an edge layer 10, an infrastructure as a service (IaaS) 20, a platform as a service (PaaS) 30, software as a service (SaaS) 40, and an application layer 50.

The edge layer 10 is configured to collect data from multiple enterprises through a unified data collector, merge collected first data based on edge computing technology, and store second data after merging in a cloud platform.

For example, the edge layer 10 may access devices through technologies such as Narrowband Internet of things (NB-IoT) and wireless local access network (WLAN), complete the collection of data from energy devices, complete data deduplication and data cleaning in combination with edge computing, upload data to the cloud platform, and perform predictive processing on the energy devices after the data are computed by the platform. The access to, protocol analysis on, and data collection on instruments, the energy devices, and Internet of things devices are performed through technologies such as Constrained Application Protocol (CoAP), Message Queuing Telemetry Transport (MQTT), and representational state transfer (REST). Real-time data of different energy media (including, but not limited to, electricity, water, gas, heat, wind, coal, and oil), data of a geographic information system (GIS), device data, video data, and other multi-source data in enterprise energy networks are seamlessly merged and stored.

The infrastructure as a service (IaaS) 20 is configured to provide a data migration function and a data service based on the second data stored in the cloud platform.

The infrastructure as a service (IaaS) 20 provides a public cloud, a private cloud, and a hybrid cloud to support mass data storage, mass data computation, security management, and log processing of the industrial Internet-based smart energy management and control platform. The infrastructure as a service 20 adopts a self-built cloud in cooperation with a third-party public cloud. An interface standard CPI of the infrastructure as a service 20 is constructed so that the platform can achieve smooth migration between different IaaSs 20 of different enterprises. The real-time data of energy such as electricity, water, gas, heat, wind, coal, and oil, the data of the GIS, the video data, the device data, and other multi-source mass data in enterprises are stored in multiple manners, the public cloud+the private cloud+localization, ensuring data security and supporting fast data queries and calls.

The platform as a service (PaaS) 30 is configured to perform data monitoring and data analysis on the multiple enterprises based on the function and the service provided by the infrastructure as a service 20.

The platform as a service (PaaS) 30 is the core of the entire industrial Internet-based smart energy management and control platform. The platform as a service (PaaS) 30 includes core modules such as a big data application sub-platform, an energy big data sub-platform, a security and control big data sub-platform, an environmental protection big data sub-platform, and a production big data sub-platform.

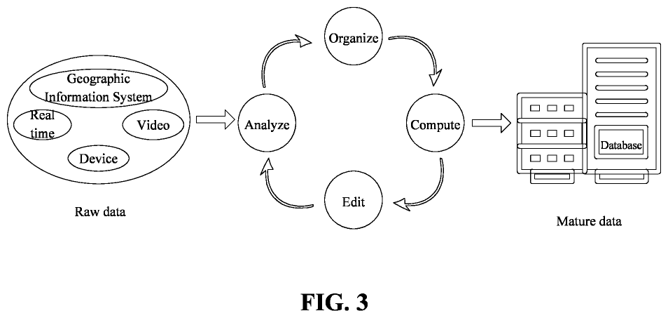

In an embodiment, the big data application sub-platform can convert multi-source raw data, such as the real-time data of different energy media (such as electricity, water, gas, heat, wind, coal, and oil), the data of the GIS, the video data, and the device data in the enterprise energy networks, into mature data through computation, statistics, storage, conversion, and human-computer interaction. As shown in FIG. 3, unified service and management including a model, a graphic, a database, a formula computation and statistic, an alarm service, a curve service, a report service, and system management may be provided for different application modules. Various applications are designed uniformly on the platform so that the applications have completely consistent operating environments, multi-source data interfaces, application programming interfaces, and seamlessly shared graphics. This plug-and-play modular design provides a system with good scalability. An energy management system based on an integrated data processing platform can be more standardized, more open, easier to build and extend, more reliable, and securer.

Optionally, data processing may include a technical process of analyzing and processing data (including numerical and non-numerical data), including analyzing, organizing, computing, and editing various real-time data, GIS data, device data, and video data. The platform adopts a relatively efficient programming language and a relatively good algorithm to quickly identify normal data, suspicious data, erroneous data, and dead data, so as to perform processing in a real-time database.

The data processing may include processing of energy data, GIS data, and video data, data computation, state estimation, breakpoint resumption, increment determination, and computation of an amount of calculation and an amount of integration.

For example, the processing of the energy data may include parsing, checking, and classifying data of different types of energy in integer, floating-point, character, and Extensible Markup Language (XML) formats so as to automatically distinguish normal data and dead data.

For example, the processing of the GIS data may include storing the GIS data in a relational database and a spatial database.

For another example, the processing of the video data may include storing the video data in a database or uploading the video data to a user interface.

For another example, the data computation may include various arithmetic and logical operations for obtaining engineering data.

For another example, the state estimation may include analyzing data by a least squares method and monitoring and distinguishing bad data to find suspicious data, erroneous data, and dead data.

For another example, the breakpoint resumption may include automatically recording an abnormality time when an abnormality such as a server abnormality or a channel interruption occurs and automatically obtaining energy data from the abnormality time after the system recovers so that the completeness of the energy data is ensured.

For another example, the increment determination may include automatically filtering data exceeding an increment to ensure the authenticity and effectiveness of the energy data.

For another example, the computation of the amount of calculation and the amount of integration may include automatically integrating a set instantaneous quantity into a cumulative quantity, automatically calculating data based on a set formula, and providing the data to the real-time database.

Data of the energy big data sub-platform are merged with data of the production big data sub-platform, the security and control big data sub-platform, and the environmental protection big data sub-platform so that information islands are eliminated, and data sharing is achieved; scientific scheduling and management of energy are achieved; the enterprises have a clearer understanding of their energy bills through energy measurement and multi-dimensional statistical analysis; enterprise managers have an accurate control over energy costs and development trends of the enterprises through various methods such as energy analysis, dynamic tracking of energy, energy statistics, energy-consuming device management, and measurement device management; energy losses are timely discovered and energy loss risks are eliminated through the tracking of energy-consuming devices and energy consumption, thereby preventing the enterprises from energy waste and providing strong support for the comprehensive informatization of the enterprises.

The energy big data sub-platform implements centralized and flattened dynamic monitoring and digital management on the supply and consumption of energy media such as electricity, water, gas, and heat in the enterprises so as to accelerate energy information uploading and improve energy utilization efficiency. In this manner, information islands are eliminated, and data sharing with “smart factories” and “group energy management networks” is achieved.

The software as a service (SaaS) 40 is configured to provide a business management and control function based on a data monitoring result and a data analysis result of the platform as a service 30.

The software as a service (SaaS) 40 may include functions such as an APP, cloudified software (such as WEB which is an application that the user can access through a webpage), a push service (such as short message service, SMS), an offline application, and a WeChat mini-program, which facilitates the application of platform functions by enterprise management and business personnel to multiple scenarios such as mobile terminals, personal computers (PCs), and devices. Multiple operating systems are supported. For mobile phones, Android and Apple IOS are optionally supported and module permissions can be freely configured. Meanwhile, through the platform functions of the SaaS in multiple scenarios, mechanisms such as field problem alert and big data analysis and prediction are established. Alert information is acquired in real time and process in time in multiple manners such as mobile terminals. The processing of an alert problem is confirmed in a closed-loop manner. The entire process of each alert problem in a control center can be checked in real time.

The APP may combine, based on components provided by the platform as a service 30, digital service components according to business needs to form various different energy management APPs. An energy monitoring APP displays an energy network so that a real-time energy consumption state can be intuitively understood and energy venting and leakage can be checked in real time according to the hierarchical relationship and difference values in the energy network, thereby quickly locating a fault point.

The cloudified software may establish, based on the platform as a service 30, a unified operating table of a full-process energy management and control matrix of an enterprise and continuously expand and establish a smart management and control product matrix based on multi-source energy data collected by the unified operating table. The cloudified software provides an alert system that can quickly respond to monitoring data such as pressure, flow, temperature, device operation state, device maintenance times, quality alert, imbalance alert, and venting and leakage alert, thus facilitating the immediate discovery of problems in energy use, device operation, energy quality, and energy imbalance and the quick location of fault points by an energy and power department and providing a basis for energy saving.

The push service and the WeChat mini-program are used for sending an alert when the alert is generated so that a monitoring image can be directly switched to a relevant image, where an alert object changes its color or flashes as a prompt in the image, a detailed description of alert content is included in an alert item, and a voice alert can report specific information of the alert item, and even specified alert content can be sent to a set mobile phone through information customization. In this manner, maintenance personnel can know a system fault in time anytime and anywhere. A smart alert sub-system based on advanced retrieval technology can classify and screen massive items and allow operators to process system faults calmly.

An operating state of the energy network is monitored in real time, an energy efficiency level of a device is evaluated based on collected operating data, and a possible low-efficiency state of a key device is prompted, so as to help a manager find energy consumption shortages in time and develop energy saving potentials. Operating states of key energy-consuming devices are monitored in real time and a possible low-efficiency state of a device is prompted. The system provides built-in standard monitoring schemes for common energy-consuming devices in an industrial field, such as a water pump, a fan, and a transformer. The user only needs to select a corresponding standard monitoring scheme according to the type and the model of an energy-consuming device, and then the system can evaluate the energy efficiency level of the device according to collected (or manually collected and inputted) operating data, prompt abnormal energy consumption of the device (deviating from an energy efficiency level of a standard product of the same type), and cumulatively calculate the abnormal energy consumption over time periods and convert the abnormal energy consumption into abnormal energy consumption costs. This helps managers find energy consumption shortages in time and develop energy saving potentials.

The application layer 50 is configured to provide an energy management scheme for the software as a service 40.

With the industrial Internet-based smart energy management and control platform according to the embodiment, data can be collected, managed, and controlled in a unified manner. Relying on information technology such as the industrial Internet, communication technology, and measurement and control technology and knowledge such as statistics and operations research, the platform implements the unified collection, classified processing, automatic calibration, and comprehensive scheduling of multi-type and multi-source data. An industrial platform as a service including technologies such as data modeling, mobile development services, industrial components, and big data is applied so that the unified analysis and processing of various types of energy data are achieved. Industrial software as a service is applied to provide information processing manners in multiple scenarios, including functions such as the APP, the cloudified software (such as WEB), the push service (such as SMS), the offline application, and the WeChat mini-program so that the management and business personnel of the enterprises can conveniently query and report energy data information quickly and in real time, actively push an alert image, and confirm an alert problem in a closed-loop manner.

Computer program codes for performing operations in the embodiments of the present application may be written in one programming language or a combination of multiple programming languages. The preceding programming languages include object-oriented programming languages such as Java, Smalltalk, C++ and also include conventional procedural programming languages such as “C” or similar programming languages. Program codes may be executed entirely on a user computer, partly on a user computer, as a stand-alone software package, partly on a user computer and partly on a remote computer, or entirely on a remote computer or a server. In the case where the remote computer is involved, the remote computer may be connected to the user computer via any type of network including a local area network (LAN) or a wide area network (WAN) or may be connected to an external computer (for example, via the Internet through an Internet service provider).

Flowcharts and block diagrams among the drawings illustrate the architecture, functions, and operations of possible implementations of systems, methods, and computer program products according to various embodiments of the present application. In this regard, each block in the flowcharts or block diagrams may represent a module, a program segment, or part of codes that contains one or more executable instructions for implementing specified logical functions. It is also to be noted that in some alternative implementations, the functions marked in the blocks may occur in an order different from those marked in the drawings. For example, two successive blocks may, in fact, be executed substantially in parallel or in a reverse order, which depends on the functions involved. It is also to be noted that each block in the block diagrams and/or flowcharts and a combination of blocks in the block diagrams and/or flowcharts may be implemented by a special-purpose hardware-based system that performs a specified function or operation or implemented by a combination of special-purpose hardware and computer instructions.

1. An industrial Internet-based smart energy management and control platform, comprising: an edge layer, an infrastructure as a service, a platform as a service, software as a service, and an application layer; wherein
the edge layer is configured to collect data from a plurality of enterprises through a unified data collector, merge collected first data based on edge computing technology to obtain second data, and store the second data in a cloud platform;
the infrastructure as a service is configured to provide a data migration function and a data service based on the second data stored in the cloud platform;
the platform as a service is configured to perform data monitoring and data analysis on the plurality of enterprises based on the data migration function and the data service provided by the infrastructure as a service;
the software as a service is configured to provide a business management and control function based on a data monitoring result and a data analysis result of the platform as a service; and
the application layer is configured to provide an energy management scheme for the software as a service.

2. The platform according to claim 1, wherein the edge layer is configured to collect data from instruments, sensors, energy devices, and Internet of things devices of the plurality of enterprises through the unified data collector.

3. The platform according to claim 1, wherein storing the second data in the cloud platform comprises storing the second data in at least one of a public cloud, a private cloud, or a hybrid cloud.

4. The platform according to claim 1, wherein the infrastructure as a service is configured to support, based on a unified interface standard cloud platform integration (CPI), a migration of the first data between the cloud platform and each enterprise of the plurality of enterprises.

5. The platform according to claim 1, wherein the data service comprises:
a cloud storage service, a virtual machine service, a network service, a log service, and a security service.

6. The platform according to claim 1, wherein the business management and control function comprises a field problem alert function and a big data analysis and prediction function.

7. The platform according to claim 1, wherein the software as a service comprises at least one of an application (APP) function, a cloudified software function, a push service function, an offline application function, or a WeChat mini-program function.

8. The platform according to claim 1, wherein the energy management scheme comprises a water management scheme, an electric energy management scheme, a compressed air management scheme, a steam heat management scheme, and a special gas management scheme.

9. The platform according to claim 1, wherein collecting data comprises at least one of collecting real-time data of a predetermined medium, collecting data of a geographic information system, collecting device data, or collecting video data;
wherein the predetermined medium comprises at least one of electricity, water, gas, heat, wind, coal, or oil.

10. The platform according to claim 5, wherein the cloud storage service comprises:
migrating the first data collected by the edge layer between the plurality of enterprises through a predetermined interface standard.
